(19) United States
(12) Patent Application Publication
(10) Pub. No.: US 2007/0200664 A1
(43) Pub. Date: Aug. 30, 2007

(54) System and method for providing and tracking equipment

(75) Inventors: Michael A. Proska, Oakville (CA); James R. Edwards, Mississauga (CA)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(73) Assignee: 1673892 Ontario, Inc.

(21) Appl. No.: 11/364,523

(22) Filed: Feb. 27, 2006

(51) Int. Cl. G05B 19/00

(52) U.S. Cl. 340/5.42; 340/5.61; 340/5.65; 340/5.72

(57) ABSTRACT

A remote rental store system that includes (a) a remote store monitor located at a rental location, the remote store monitor including: (i) a wireless receiver for receiving wirelessly transmitted signals from a plurality of mobile rental units located at the remote rental location; and (ii) a store controller connected to the wireless receiver for generating rental unit usage data for the rental units in dependence on the signals and providing the rental unit status data over a communications link; and (b) a management controller, at a location that is remote from the rental location, for receiving the rental unit usage data through the communications link from the store controller and periodically determining a rental charge for the rental units in dependence on the rental unit usage data.

### FIELD OF THE INVENTION

This application relates generally to equipment information tracking and processing and, more specifically, to an apparatus and method for providing and managing assets at remote sites.

### BACKGROUND OF THE INVENTION

The equipment rental industry is a capital intensive business that requires constant monitoring of customer demand and equipment utilization according to numerous variables and measurables such as rental equipment type, geographic area, seasonality, and other factors in order to optimize fleet mix and rental rate models. Competitors must rigorously control fixed overhead, labour costs, equipment maintenance, and other costs to be successful in the long-term. Excellent customer service, defined as being able to reliably provide quality equipment when and where it is required by the end user, is also recognized by industry participants as critically important to acquiring and maintaining market share. Currently, there exists no adequate integrated solution for tracking and managing assets in remote equipment rental stores.

Accordingly, a system that provides an improved system and method for tracking and managing assets in remote equipment rental stores is desired. A system that can be used to provide and track non-rental assets to remote cites is also desired.

### BRIEF SUMMARY OF THE INVENTION

According to one aspect of the invention there is provided a remote rental store system that includes (a) a remote store monitor located at a rental location, the remote store monitor including: (i) a wireless receiver for receiving wirelessly transmitted signals from a plurality of mobile rental units located at the remote rental location; and (ii) a store controller connected to the wireless receiver for generating rental unit usage data for the rental units in dependence on the signals and providing the rental unit status data over a communications link; and (b) a management controller, at a location that is remote from the rental location, for receiving the rental unit usage data through the communications link from the store controller and periodically determining a rental charge for the rental units in dependence on the rental unit usage data.

According to another aspect of the invention, there is provided a method for operating a remote rental facility having a secure enclosure containing a plurality of rental units that are enabled to emit RF signals. The method includes monitoring, at the remote rental facility, for RF signals transmitted by the rental units; generating rental unit usage data for the rental units in dependence on the RF signals and providing the rental unit status data to a location remote from the rental facility through a communications link; and receiving, at the location remote from the rental facility, the rental unit usage data through the communications link and periodically determining a rental charge for the rental units in dependence on the rental unit usage data.

According to another aspect of the invention, there is provided a method of operating an unattended rental location, including providing a plurality of mobile rental units in a secure enclosure at the rental location, each of the mobile rental units having an associated RF signal emitting device attached thereto for emitting an RF signal that includes identification information identifying the rental unit; monitoring at the secure location for RF signals emitted by the mobile rental units; determining, in dependence on the monitoring, when the mobile rental units are in use at the rental location and tracking over a predetermined time period for each of the mobile rental units a cumulative time duration that the mobile rental unit is in use; and determining a rental charge for each of the mobile rental units for the predetermined time period based on the cumulative time duration that the mobile rental unit is in use.

According to another aspect of the invention, there is provided an equipment provisioning system that includes a mobile container having a lockable door; a plurality of mobile equipment units located within the container, each of the mobile equipment units having an attached RF signal emitting device attached thereto for emitting an RF signal that includes identification information identifying the mobile equipment unit; and a store monitor secured to the container, the store monitor including: (i) a wireless RF receiving device for receiving the RF signals emitted within a coverage area thereof by the mobile equipment units; and (ii) a store controller connected to the wireless receiver for generating unit status data for the mobile equipment units in dependence on the RF signals received by the RF receiving device and transmitting the unit status data over a wireless communications link.

### BRIEF DESCRIPTION OF THE DRAWINGS

Reference will now be made to the drawings, which show by way of example, embodiments of the invention, and in which:

FIG. 1 is a schematic block diagram of a system for tracking and managing assets in remote equipment rental stores;

FIG. 2 is a schematic block diagram of an example of a data collection unit used in the system of FIG. 1;

FIG. 3 shows in flowchart form a method for establishing and operating a remote equipment rental store utilizing the system of FIGS. 1 and 2; and

FIG. 4 shows in flowchart form a method for tracking and managing assets in remote equipment rental stores.

In the drawings, like references or characters indicate like elements or components.

### DETAILED DESCRIPTION OF EXAMPLE EMBODIMENTS

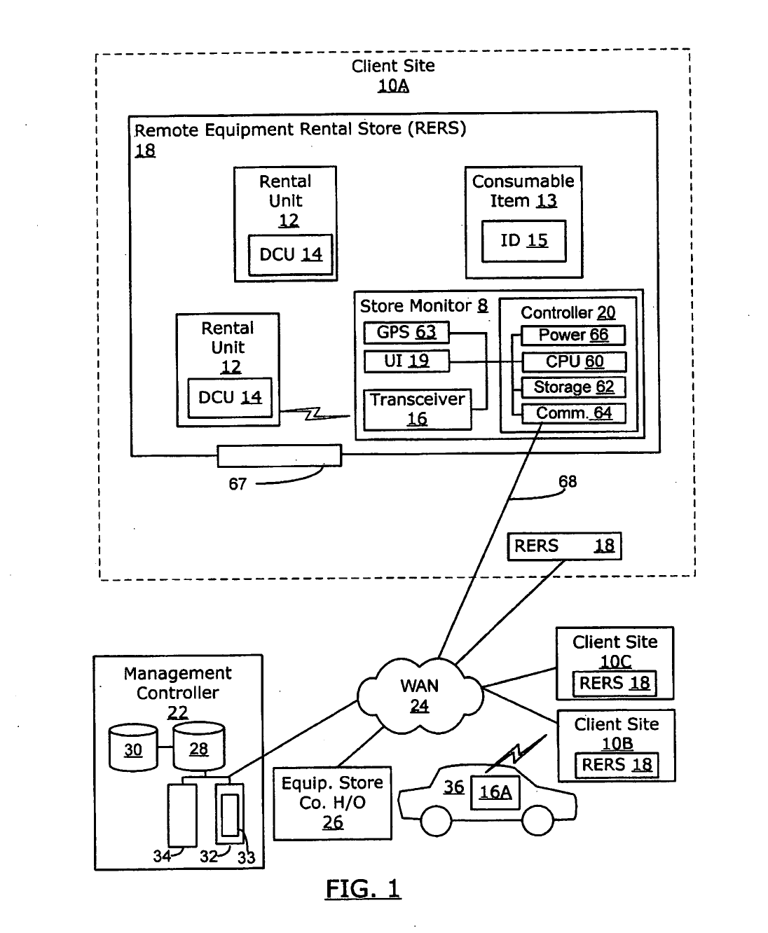

With reference to FIG. 1, a brief overview of a system for tracking and managing assets in remote equipment rental stores will be provided. In example embodiments, the remote equipment rental stores are automated stores that are unmanned or unattended in that a representative of the company that provides or operates the remote equipment rental store is generally not present at the site of the store. In some example embodiments a representative of the rental company can be present on-site at the rental store at least periodically. As used herein the terms “lease” and “rent” are synonymous. In one embodiment, the remote equipment rental stores (RERS) 18 comprise secure storage locations. The RERSs include secure storage locations, including by way of non-limiting example, fenced-in areas, shipping containers (for example, marine, rail, truck, and/or air cargo containers), cube vans, or any other container suitable to the secure delivery and/or set-up and monitoring provisions needed to operate an unattended equipment rental store. The RERSs each include at least one rental unit 12 that has an on-board Data Collection Unit (DCU) 14 for tracking usage and other status information about the rental unit 12. The rental units 12 include any equipment that would typically be delivered for rental to a customer in a RERS, including by way of non-limiting example, industrial equipment such as forklifts, cranes, bulldozers, paving equipment, tools, etc., construction equipment such as power tools, generators, jack hammers, etc. The RERS 18 could also include consumable items 13 that can be sold to and used by a customer, such as safety equipment, saw blades, replaceable equipment parts such as filters, and construction materials such as lumber or nails. Consumable items 13 could also include “returnables” that are used with the rental equipment (items that become worn through use and are then returned to be refurbished, such as, for example chisels for jack hammers that are used and then returned for resharpening and reforging). Each RERS 18 also includes a store monitor 8 for receiving and tracking status information about the rental units 12 from the DCU's 14, and also for tracking information about consumable items 13.

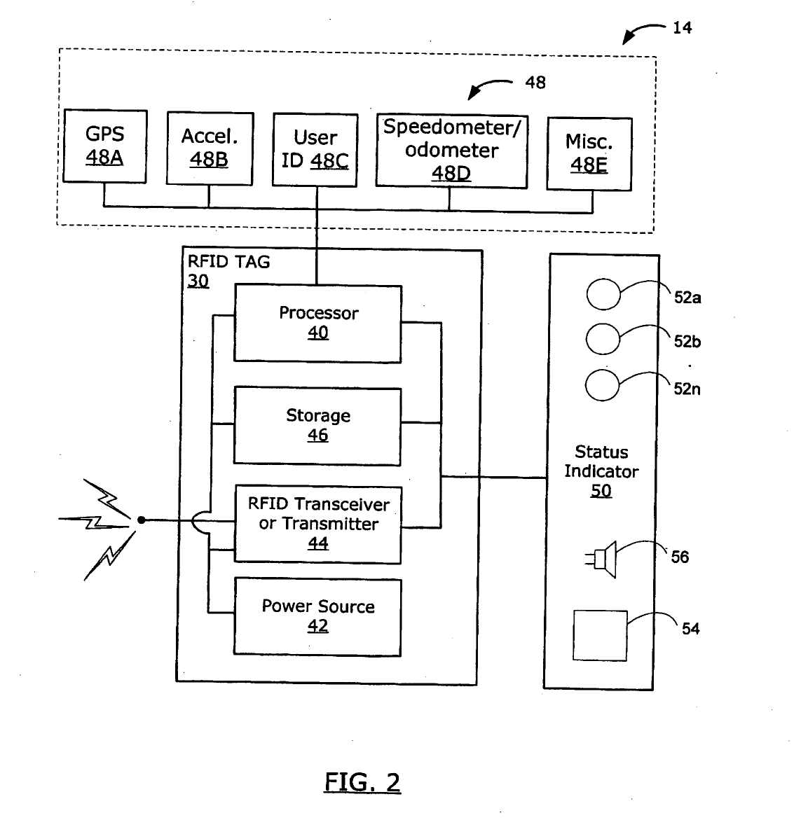

In one embodiment, each DCU 14 is configured to collect usage information, and possibly other status information related to its associated the rental unit 12. The DCU 14 is typically securely mounted on its associated rental unit 12, particularly if the rental unit 12 is an item exceeding a predetermined value (e.g., all items worth more than $100 may have a securely attached DCU 14). In one embodiment, each rental unit 12 has its own DCU 14 for monitoring its usage information. As will be described further below, in an embodiment, the DCUs 14 are each enabled through active Radio Frequency Identification (RFID) technology to transmit rental unit 12 usage information to transceivers a store monitor 8. Typically, in use each remote equipment store 18 is associated with a particular client site (referenced herein individually as 10A, 10B, and 10C and generally as 10). In some embodiments, more that one RERS may be located at a client site. The DCUs 14 generally have on-board battery power supplies and communicate periodically via radio waves (e.g., within the Industrial, Scientific and Medical (ISM) frequency bands) with a Radio Frequency (RF) Reader (transceiver 16) of the store monitor 8 when they are within range of such receivers. Each DCU 14 has a unique identification number that is associated with the specific rental unit 12 to which the DCU 14 is mounted. The DCUs 14 may include onboard or attached sensors to detect status information about its rental unit 12, including for example, rental unit movement, engine startup and shut down, operating hours, physical impacts or collisions, battery state, location and/or other metrics, as required. The DCUs 14 also contain onboard memory to store sensor data (for example, when the rental units 12 are out of RF range of the store monitor 8). The DCUs 14 may be equipped with tamper-detection systems to notify store monitor 8 if the DCU 14 is removed from a product 12. The DCUs 14 are described in greater detail below in connection with FIG. 2.

In FIG. 1, a representative client site 10A is shown in greater detail, and may, for example, be a construction site, a manufacturing facility, a retail facility, combinations of the forgoing, or another type of facility. In one embodiment, the client site 10A has at least one RERS 18, which is a secure area such as a lockable shipping container or a fenced-in area, having a locked entrance or door 67. In some embodiments, the client site 10A may include a number of different RERS 18 in which rental units 12 are present and available for rental or purchase. For example, one store 18 may be a heavy equipment construction store of the site 10A, another store 18 a power tool and light equipment store, and a further store 18 a supplies or consumables store. In an example configuration, each container store 18 includes a store monitor 8. Each store monitor 8 includes one or more receivers or transceivers 16 (which are active RFID tag readers in at least one example embodiment) for periodically receiving status information from the DCUs 14 related to the rental units 12 located within and/or associated with the store 18. The store monitor 8 may also include a user interface 19 that includes an input device such as a keypad, bar code scanner and/or passive RFID reader. The interface 19 allows a user to purchase (or rent) items that do not have the DCU 14 such as consumable items 13 or low value equipment. The interface 19 may also include a keypad or other user entry device accessible from outside the RERS 18 to facilitate, for example, entry of a security code that allows the RERS 18 to be accessed. The store monitor 8 includes a local store controller 20 to which the transceiver 16 and user interface 19 are connected. The controller 20, which may include volatile and/or non-volatile memory storage 62, a processor or CPU 60 executing a suitable software program (e.g., middleware), and a communications interface 64 for transmitting collected information to a central rental management controller 22. In the case where the RERS 18 is a shipping container, substantially all of the store monitor 8 may be securely located within the container, with an external antenna connected to communications interface 64. In at least some example embodiments, the store monitor 8 includes a self-contained power supply 66, such as a rechargeable battery, and may also include a standard AC connection for getting power from an external AC power source to power the store monitor and/or recharge the battery. A solar collector can also be connected to an outer surface of the shipping container as a source of power. In the case of a fenced-in rental store 18, all or part of the store monitor 8 components will typically be located within the store enclosure. In some embodiments, the store monitor 8 can include a GPS receiver 21 so that the location of the RERS 18 can be tracked in real-time.

The transceiver 16 passes status data received from in-range DCUs 14 to the store controller 20 where the middleware interprets the binary data and stores information with an associated time stamp in a standard format (e.g., comma delineated text) that may be imported into an asset management application. The store controller 20, which at least temporarily stores data received from the transceivers 16, may compile the received data and make it available to an owner or operator of the RERSs 18. Additionally, the site controller 20 may perform some data analysis on the data. However, the site controller 20 is connected through a communications link 68, if such a connection is available at the client site 10A, with a rental management controller 22, which may be implemented by one or more servers or computer systems. Where such a connection exists, at least some of the compilation and analysis of data collected from the DCUs 14 may be performed by the rental management controller 22. The communications link 68 can include, among other things, a direct hard-wired Internet connection, a Wide Area Network (WAN) 24 (such as the Internet), a cellular connection, a satellite uplink, a high-frequency microwave communications network, or any other type of communications link. The rental management controller 22 receives and processes time stamped data from the site controllers 20 of the store monitors 8 located at each of the client sites 10, and provides processed data through a communications link (which may include, among other thing, the WAN 24, a direct link or a local or enterprise network, or combinations thereof)to an equipment store company head office 26. The rental management controller 22 includes an application database 28, a benchmarking database 30, an application server 32, and a WEB server 34.

In some embodiments, service vehicles 36 equipped with transceivers 16A may be used to periodically capture data from the store controllers 20 of the stores 18 to serve as a communications link 68 for locations where there are no permanently available communication links 68, for example, at remote locations such as in the mountains or deep in the country where it is not economically feasible to utilize permanent infrastructure for the communications link. The information collected by the service vehicle 36 may then be uploaded to the rental management controller 22, through either the WAN 24 or a direct connection.

In some embodiments, the store controller 20 can be located separate from the transceiver 16 and user interface 19—for example, a single local controller 20 may be used in some embodiments to collect information where multiple stores 18 are located at a client site. Thus, where there are multiple RERS 18 at a client site, a single local store controller 20 (which may for example be physically located at the store monitor 8 of one of the RERS 18, or which may be centrally located in relation to the client site 10A) may be linked by communication links (which may be wireless and/or wired link to all of the transceivers 16 of all stores 18). Alternatively, each of the store monitors 8 in a multi-store site can have its own store controller 20.

Where approved by individual customers, equipment utilization and other data may be exported from customer specific asset management applications (such as the application database 28 and associated applications) to the benchmarking database 30 to enable statistical analysis and benchmarking to facilitate continuous improvement of rental operations. The application server 32 hosts an asset management application 33, which associates data obtained from the DCUs 14 through the middleware application of store controllers 20 with equipment rental rates, equipment reservations, and other information necessary to provide appropriate service and invoice end-users. The asset management application 33 also, in example embodiments facilitates flexible reporting and queries to the benchmarking database 30. The web server 34 hosts a graphical user interface (GUI) system that presents information generated by the asset management application 33 for ease of review (e.g., in a WEB browser readable format). The functionality of the management controller 22 can be implemented on a single server, or may be distributed amongst multiple servers/computers that are at a single location or that are spread out amount various physical locations.

Referring to FIG. 2, features of the system for tracking and managing assets in remote equipment rental stores will now be described in greater detail. FIG. 2 shows an example of the DCU 14 for the rental unit 12 in greater detail. In one embodiment, the DCU 14 includes an active RFID TAG 30 that is configured to sense and track status information about the rental unit 12 that hosts the DCU 14. The RFID TAG 30 generally includes a processor 40, a power source 42, an RFID transmitter or transceiver 44, and a storage device 46. In order to sense status information, the DCU 14 includes or receives inputs from a number of interface devices or sensors (referred to generally by reference number 48). Such sensors may include, for example, a global positioning sensor 48A, an accelerometer sensor 48B, a user identification sensor or input device 48C, a speedometer or odometer sensor 48D, and other miscellaneous sensors 48E. The global positioning sensor 48A, accelerometer sensor 48B, user identification sensor or input device 48C, and speedometer or odometer sensor 48D and/or other sensors 48E provide real-time operating data about the rental unit 12, for example, the location of the rental unit 12 (e.g., whether the rental unit 12 is inside or outside its associated store 18), any accelerational forces being exerted on the rental unit 12 (which can be used to indicate of the rental unit 12 is being moved, the identification of the user or company currently using the product 12, and the speed or current odometer readings of the rental unit 12 (e.g., if the rental unit 12 is a vehicle such as a bulldozer or other material handling unit). The data collection unit 14 may further include a status indicator 50 for showing the user of the rental unit 12 various status indications (e.g., whether the current location and/or operating conditions of the rental unit 12 result in the rental unit 12 being considered to be not in use such that the client is not currently paying rent for the rental unit 12 or in use and in a rented state such that the client is being charged rent). The status indicator 50 includes a number of status indicator lights 52a-n, individually indicated as 52a, 52b, . . . , 52n, a button 54, and an audible device 56, such as a speaker.

In the operation of the remote equipment rental store 18, the client may wish to rent a particular one of the rental units 12 and therefore removes the rental unit 12 from the RERS 18 (e.g., the secure container). The sensors 48A-E continuously monitor the state of the rental unit 12 and provide respective signals to the processor 40. In an example embodiment, the processor 40 is powered by the independent power source 42. The processor 40 includes an input having an analog to digital (A/D) converter for converting the analog signals provided by the sensors 48A-E to digital signals that are processed and stored by the processor 40 in the storage device 46. The processor 40 uses the RFID transceiver 44 to periodically transmit the collected data to the transceiver 16, which is then relayed to the local controller 20. If one or a number of predetermined criteria are met, for example: (a) readings from the GPS sensor 48A indicate that the rental unit 12 has left the confines of the secure container, or readings made by the transceiver 16 indicate that the rental unit 12 has passed through the exit 67 of the RERS 18; (b) the accelerometer 48B and/or the speedometer 48D indicate that the rental unit 12 is being used; (c) a user or client enters his user ID into the user interface 48C; or (d) the engine of the rental unit 12 has been activated, or combinations of the forgoing then the DCU 14 and/or the store controller 20 registers that the rental unit 12 is being used and, therefore, from a tariff perspective, is rented. Similarly, the occurrence of one or more predetermined criteria can be used to indicate the end of a rental, for example, (a) location data may indicate that the rental unit 12 has been returned to the confines of the RERS 18; (b) the accelerometer 48B and/or the speedometer 48D indicate that the rental unit 12 has stopped being used; (c) a user or client enters a specified code into the user interface 48C; or (d) the engine of the rental unit 12 is deactivated, or combinations of the forgoing, and then the DCU 14 and/or the store controller 20 registers that the rental unit 12 is no longer being used and, therefore, from a tariff perspective, and the rental charges should cease. In various configurations, the data from sensors 48 may be analyzed at the tag processor level 30 to determine if the conditions indicating commencement or termination of a rental state have occurred, in some embodiments, such data analysis may occur at the store controller 20 level, in some configurations such data analysis may occur at the rental management controller 22 level, and in some configurations such data analysis could be spread out over multiple levels and/or be independently performed at multiple levels and the results of the analysis communicated between the various levels. Thus, based on status information provided by DCU's 14 and collected by store monitors 8, accurate and secure use-based tracking of rental units 12 is facilitated and rental charges that are calculated at the rental management controller 22 can be determined in dependence on such information. For example, one rental rate may be charged for time periods for which it is determined that a rental unit 12 is out of the RERS 18; another rental rate may be charged for time periods for which it is determined that a rental unit 12 is out the RERS 18 and in active use; and no rental rate or a reduced rate may be charged for time periods when it is determined that a rental unit 12 is within the RERS 18.

In some embodiments, location information of a rental unit 12 may be determined based on information sources other than or in addition to a GPS sensor. For example, location information could simply include tracking of whether the rental unit 12 is within the confines of the RERS 18 or is not in the RERS 18, with such determination being made by detecting through transceiver 16 (or other RFID reader) that the rental unit has passed through entry/exit door 67. For example, DCU 14 could also include a passive RFID tag that is read by a short range passive RFID tag reader (which is part of interface 19) set up in close proximity to entry/exit door 67 for detecting when and the identity of any rental unit 12 passing through the door 67.

In one embodiment, to provide added security, the controller 20 may be configured to notify a responsible party within the equipment rental company by email or SMS when a piece of equipment is removed from the RERS 18 outside of defined operating hours.

In at least one example embodiment, consumables items 13 each have an identifier 15 which may include, for example, a scannable bar code or a passive RFID tag that can be read by user interface 19 such that a consumable item located in RERS 18 can be purchased by scanning the barcode or, in the case where a passive RDFID tag is incorporated into ID 15, simply by passing by a passive RFID tag reader as the item 13 passes through entry/exit door 67. In the case of items 13 that are “returnables”, the return of the item 13 as it reenters the secure area of RERS 18 can be tracked, so that the client given a partial refund or credit for returning the used item for refurbishment.

If a communications link 68 is available to the WAN 24 the store controller 20 can share the collected status data from all of the rental units 12 with the rental management controller 22 over the WAN 24. The consolidated data from multiple RERS 18 may then be available for analysis at the equipment store company head office 26 using, for example, the WEB server 34.

Each RFID TAG 30 in use provides the transceiver 16 with status information including the identity, location, and operating data of its respective rental unit 12. Such data can be used at at least one of store monitor controller 20 and/or rental management controller 22 to track real-time (or near real-time) information such as a physical inventory of rental units 12 remaining in a particular store 18 (e.g., the RFID TAG 30 associated with each product 12 may provide to the transceiver 16 self-identification information such that the store controller 20 knows exactly which rental units 12 are in use at the site 10A or absent from the store 18A and which rental units 12 are present in the store 18A), the real-time operating conditions of the rental units 12 that are currently within range of the transceiver 16, and other critical status notifications such as unusual operating conditions, the rental units 12 requiring preventative maintenance (e.g., based on an odometer reading or cumulative time-in-service), etc.

The unique identification of each DCU 14 is linked to a unique identifier for its associated rental unit 12 (for example, a rental unit may have a a unique serial number or other identifying code), and such identification information may be linked at store and/or rental management controller s 20 or 22 to data such as the origin of the rental unit 12 and the date and time at which the rental unit 12 was put into service. Additionally, in one embodiment, the status indicator 50 responds to a push of the button 54 by providing the user of the rental unit 12 with extended condition reporting using the status indicator lights 52. The status indicator lights 52 may be configured to report any desired conditions to the user, such as information regarding whether the rental unit 12 is considered rented or not, whether the rental unit 12 requires maintenance, the current cost of renting the rental unit 12, emergency status alerts, etc. Additionally, such alerts may be provided using the audible device 56.

The store controller 20 saves and compiles information on each rental unit 12 associated with the store 18. As suggested above, in some embodiments, a single controller 20 may save and compile information for multiple RERS 18 at a client site 10A. In some embodiments, the store controller 20 runs a suitable software package (e.g., middleware) to compile this information and may optionally make the information available to an authorized user of the local controller 20 in a manageable and easy to view fashion. Preferably, using the rental management controller 22, a manager of the RERS 18 may receive alerts about rental units 12 that are approaching scheduled maintenance and the current location of the associated rental units 12 such that action can be taken before the rental units 12 become disabled or malfunction. Additionally, the rental management controller 22 may allow a manager to view all of the rental units 12 in use at the client site 10A along with associated information such as the cumulative time in use and projected remaining operating time of the rental units 12 allowing the manager to schedule future maintenance or equipment swaps such that the maintenance is transparent to the client using the RERS.

Status Information regarding the rental units 12 is transmitted to the rental management controller 22, thus making the information accessible to the equipment store company head office 26. As such, data for all the rental units 12 in use across the rental company's rental sites (e.g., the client sites 10A, 10B, and 10C) may be viewed together using one interface.

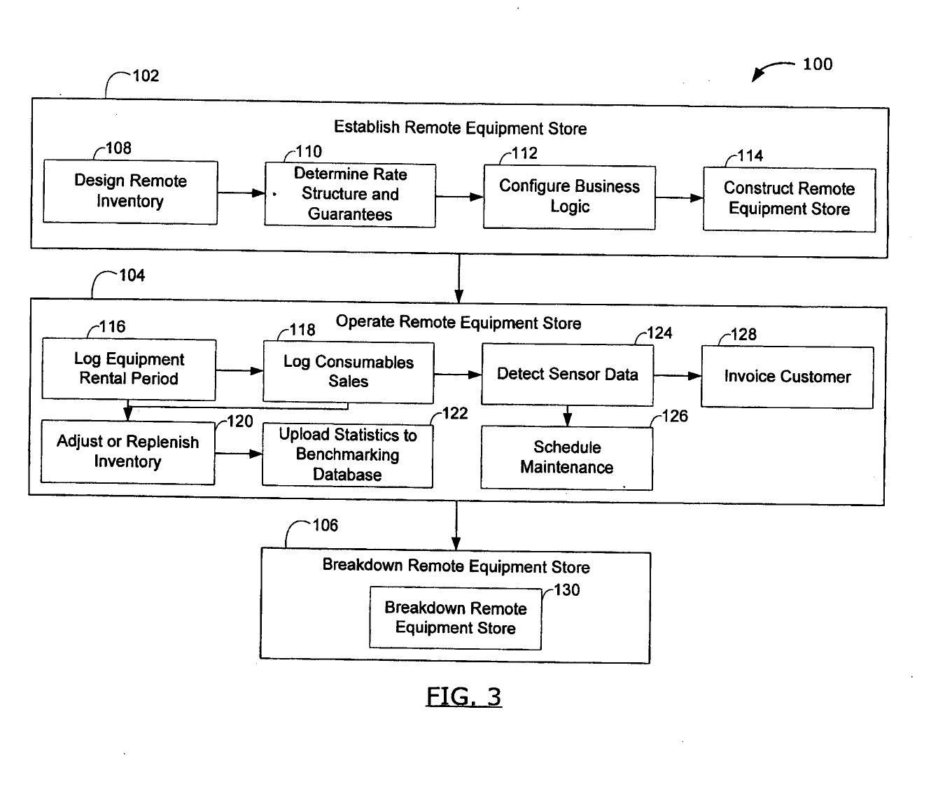

FIG. 3 shows a method 100 for establishing and operating a remote equipment rental store utilizing the system of FIGS. 1 and 2. The method 100 comprises three general steps, including the step of establishing a remote equipment rental store 102, operating the remote equipment rental store 104, and breaking down the remote equipment rental store 106.

In one embodiment, the first step 102 comprises four sub steps (which need not necessarily be performed in the exact order set out below). Firstly, once a customer orders or requests that a RERS 18 be set up to meet his particular needs at a particular job site, the equipment rental company uses its judgment and experience, coupled with data previously obtained and stored in the rental management controller 22 (e.g., in the benchmarking database 30) to optimize a remote inventory asset mix (e.g., which rental units 12 and consumable items 13 to include in the remote stores 18 to best meet the particular needs of the client) (sub step 108). This optimization may consider factors including the construction phase of the particular project for which the RERS is being ordered, the season, the distance between the RERS to be setup and the nearest fixed rental location at which more rental units 12 may be housed, and other relevant parameters. For example, a RERS 18 in the form of a shipping container for delivery to a construction project can be filled with one mix of rental equipment and consumable items if the project is at a site preparation phase, and a different mix of rental equipment and consumable items if the project is at the foundation pouring stage, and so on Next, at a sub step 110, a rate structure and availability guarantees are be determined. The rate structure and availability guarantees are typically negotiated directly with the client and comprise parameters that are entered directly into the asset management application 33 and stored in the application database 28 for each unique product 12 to be associated with the RERS 18. Standard rates may be loaded as default rates that may be overwritten for specific contracts or adjusted at the time of invoice for a particular customer discount. Next, the business logic is configured at a sub step 112. The asset management application 33 is configured with the specific business logic required by the rental equipment company. Business logic settings allow the rental equipment company to define different rental rates for different rental periods, times, sensor readings, or other factors as needed.

A final sub step 114 is to construct and set up the RERS. It will be appreciated that at least some of the following RERS setup activities can be performed well in advance of step 108. In one embodiment, the RERS is constructed by installing and suitably attenuating the transceivers or transmitters 16 such that they detect active RFID TAGS 30 within the defined area of the RERS (e.g., the store 18A) but, to the extent possible, not beyond. In the case of a marine shipping container based inventory control system, the transceivers or transmitters 16 may detect RFID TAGS 30 within the container but not outside the container since the metal walls of the container block the radio waves. If it is required that larger machinery be stored beside the container, or that then an antenna for the transceivers or transmitters 16 may be placed outside the container. DCU's 14 including active RFID TAGS 30 operating within the frequency band of the transceivers or transmitters 16 are attached to the rental units 12 that are included in the inventory equipment rental units 12 and unique ID's of the DCU's 14 associated in application database 28 with identification information for the specific rental units to which they are attached. Sensor 48, as required, are provided with the DCU's 14 and connected as required to the rental units 14. ID devices 15 are secured to consumable items 13 and associated therewith in application database 28.

As part of sub-step 114, the inventory of rental units 12 and consumable items 13 is placed into the RERS 18. In the case of a shipping container, the populating of the RERS 18 can occur at a site controlled by the rental company, and then the RERS 18 can be locked shut and securely transported to the client site 10A, where it can only be unlocked by authorized personal who knows a proper key-entry code or has a proper access card or key or matching biometric characteristic. As indicated above, in some embodiments, user interface 19 includes an security access device to permit access through entry 67 into the RERS 18; in some configurations access can be limited to certain hours of the day (which can be configurable from rental management controller 22), and in some cases, shut down altogether if a lock-down command is received by the controller 20 over communications link 68 (useful for example if the client goes into arrears on rental payments or if the client site 10A falls under control of an unexpected party, for example in a client bankruptcy). Similarly, at least some of the DCU's 14 and their associated rental units 12 could be configured such that use of such rental units could be prevented or restricted by receipt of a predetermined signal through RFID Transceiver 44.

In one embodiment, the second step 104 comprises 7 sub steps, which need not be performed in the exact order illustrated. As the remote rental store operates, equipment rental periods are logged (sub step 116). In one embodiment, the middleware running on the store controller 20 will log the start of a rental period for a specific rental unit 12 when an RFID TAG 30 is not detected within range of its respective store 18 for a predetermined period of time (e.g., 5 minutes). The middleware on store controller 20 will log the end of a rental period when the RFID TAG 30 is redetected within range of its respective store 18. Both events are transmitted via communications link 68 to the rental management controller 22 and logged and stored in the application database 28, or alternatively, just the start time and duration of the rental period is transmitted over communications link 68 to the rental management controller 22 and then logged and stored in the application database 28. As suggested above, other events can also be tracked to determine the beginning and end of a rental period.

The use of consumables 13 that are available for purchase from the RERS 18 are also logged (sub step 118). Rental equipment companies may stock the RERS with consumables 13 (including returnables) having associated ID mechanisms 15 for the convenience of its customers. In one embodiment, sales may be tracked and invoiced on a honor basis, through a standard manual vendor-managed inventory (VMI) process (e.g., through use barcode scans or code entries through the user interface 19). Alternatively, the ID mechanisms 15 could take the form of inexpensive passive RFID TAGS attached to consumables packaging and the middleware may be configured to log a sale when a passive RFID tag ID 15 is not detected for a period of time, or is detected as passing with a range of a interrogating passive RFID reader that forms part of interface 19. In the case of a returnable item, return of the worn item to the RERS 18 can be tracked so that the client can be given an appropriate credit. Such use or consumption events are tracked by store controller 20 and at least periodically transmitted over communication link 68 to the rental management controller 22 and stored in application database 28. Thus, a bar code reader or passive RFID system may be installed for retail operations that utilize the remote rental store systems for inventory management and/or end-customer invoicing purposes.

The sub steps 116 and 118 lead to a sub step 120 where rental and/or consumables inventory is adjusted or replenished. The asset management application 33 at rental management controller 22 may be configured to automatically identify and/or predict stock-out situations on certain equipment types and flag these to be considered for higher inventory levels. Inventory and equipment usage statistics collected from the ERES 18 can be uploaded to the benchmarking database 30 (step 122). Where approved by a client, selected data will be exported from the application database 28 to the benchmarking database 30. This data is used for the benefit of all clients to improve the quality of the RERS delivered to client sites, as well as the efficiency and profitability of operations.

In addition to tracking equipment usage for the purposes of determining rental periods, sensor data collected from the DCU's 14 can also be used for maintenance purposes. In this regard, as indicated at step 124, The rental equipment company may employ DCU's 14 having sensors 48 to detect and track equipment usage status or other critical data. Equipment usage status will be detected using various sensors 48 depending upon physical and operating characteristics of the rental units 12, such as whether the equipment is powered by electricity, pneumatics, or combustion. Sensors 48 may be designed and attached onto the RFID TAG 30 of a DCU 14 where warranted by business requirements (e.g., accelerometers to detect impacts). Using the sensor data collected by store monitors 8, maintenance for specific rental units 12 may be scheduled (sub step 126). The asset management application 33 at central controller 22 monitors equipment usage or other critical data and applies the appropriate logic to schedule preventative maintenance. The final sub step of the step 104 is to invoice the customer (sub step 128). The asset management application 33 of rental management controller 22 calculates rental periods and applies the necessary logic to determine the rate applicable to each piece of equipment and length and timing of the rental periods used by the client. The asset management application 33 produces invoices as required by the equipment rental company. Such invoices may be generated in paper form and sent to clients, and/or may be electronically sent or accessible to clients through WAN 24.

The step of breaking down the remote equipment store (step 106) comprises one sub step 130, involving breaking down the RERS 18. The RERS may be relocated and reconfigured as required. The DCU's 14 may be removed and associated with other pieces of equipment, if needed.

In some example embodiments, clients are permitted to piggy-back on the infrastructure shown in FIG. 1 in that DCU's 14 can be placed on equipment units owned by the client or leased by the client from a different source other than the rental company, and the information from such DCU's collected and tracked through the controller(s) 20 of remote stores located at the client site 10A. This “client owned equipment” information gathered from one or more client sites can be tracked at rental management controller 22 and accessed by clients (for example through VPN connections through WAN 24) for their own inventory control and maintenance scheduling purposes. The rental company can offer such service to the client on a fee-basis, or as a free service to build goodwill or to gather additional information so that the rental company can offer additional services to the client. For example, based on comparisons of the information gathered from “client owned equipment” with information contained in benchmarking database 30, the rental company operator of the rental management controller 22 may determine that inefficient usage of client owned equipment is occurring that could be resolved by reallocating the “client owned equipment” and renting further equipment from the rental company. The rental company can then use this information to provide a business case to the client to rent additional equipment from the rental equipment.

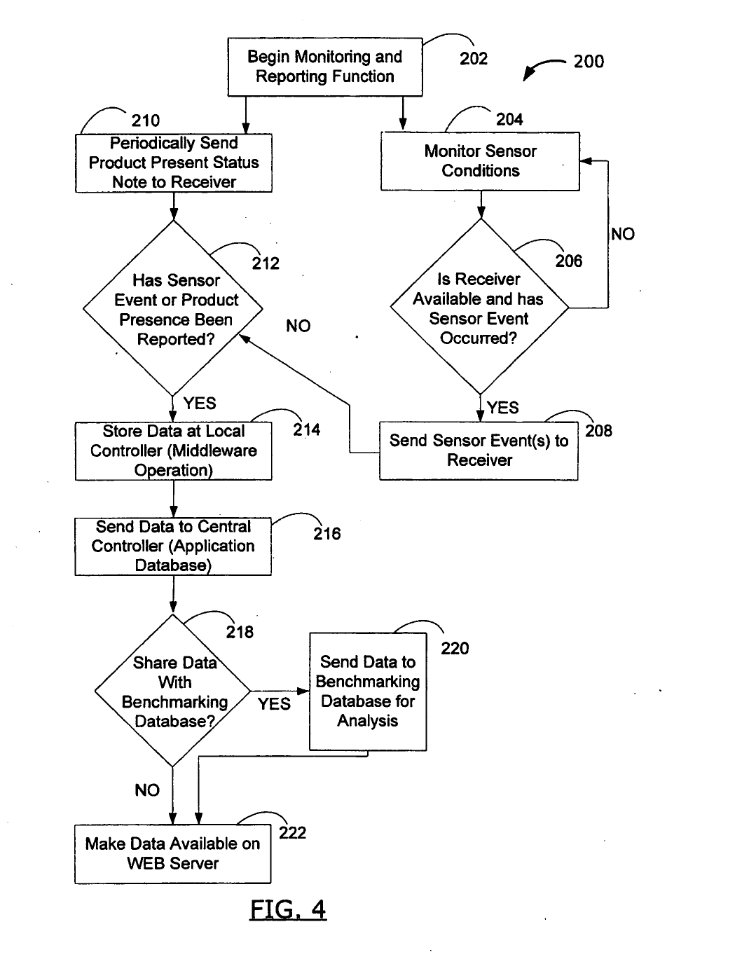

FIG. 4 shows in flowchart form an embodiment of a method 200 for tracking and managing assets in remote equipment rental stores. The method 200 is typically executed by the systems shown in FIGS. 1 and 2 during the step 104 (FIG. 3) of operating the RERS. In a first step 202, the monitoring and reporting function begins. The step 202 leads directly to a step 204, where sensors (e.g., the sensors 48 shown in FIG. 2) are monitored (e.g., by the processor 40 of DCU 14) for changing conditions (e.g., is there any indication that the rental unit 12 is in use?). A decision step 206 continually checks to see if a sensor event has occurred and, if so, if an RF reader 16 of a store monitor 8 is available. If a sensor event has not occurred, the method returns to the step 204. If a sensor event has occurred and the receiver is not available, the event is temporarily stored (e.g., in the storage 46 of FIG. 2) and the method returns to the monitoring step 204. If the receiver is available, or if a previously unreported sensor event has occurred and the store monitor receiver 16 is now available, information about the sensor event(s) are sent to the receiver 16 (step 208). In an example information, such information will include a unique identifier for the DCU 14 and information identifying the nature of the sensor event, and where necessary a magnitude. The information that is sent may be time stamped at the DCU and/or at the store monitor 8 when it is received.

In one example embodiment, while the steps 204, 206, and 208 are being executed by the DCU 14, step 210 is also performed concurrently by the DCU 14. The RFID TAG 30 of the DCU 14 periodically sends out “product present” status notes to the receiver 16 of store monitor 8 (e.g., the DCU 14 may report its presence in the store 18A to the receiver 16 every five minutes). Such product present messages will include the unique identifier of the DCU 14, and can be time stamped by the DCU 14 and/or the store monitor 8. Step 210 and steps 204-208 are repeatedly and independently performed by all the DCUs 14 associated with the RERS 18. Next, at the step 212, it is determined whether sensor events or product present status notes have been reported to the store controller 20 (FIG. 1) by the RFID TAG 30. If either a sensor event and/or a product presence signal has been detected by the store controller 20, such events are stored at the store controller 20 (step 214). These events stored at the store controller 20 form the basis for the middleware, running on the store controller 20, to make decisions relating to the starting and/or stopping of the rental clock for the particular product 12. In one embodiment, products that are continually reported as being present and are not experiencing any predetermined sensor events are not considered to be rented, while products that are absent from the store 18A and/or are experiencing sensor events (e.g., a vehicle in motion) are considered to be in use and, consequently, rented.

Collected DCU data stored at the store controller 20 at the step 214 is periodically sent to the rental management controller 22 (FIG. 1) and stored in the application database 28 (step 216), if a communications link 68 with the WAN 24 is available. Steps 212, 214c and 216 are repeatedly performed by the store monitor 8.

At the rental management controller, the asset managm3nt application 33 (step 218) determines whether the particular data transferred to the rental management controller 22 (e.g., to the applications database 28) has been authorized by the client associated with the data to share such data with the benchmarking database 30. If such authorization has been given, the data added to the application database 28 is shared with the benchmarking database 30 (step 220). Whether the data is shared or not, the final step of the method 200 is to make the data available on the WEB server 34 (step 222) for use by employees of the rental company (e.g., located at the head office 26) for appropriate analysis and use (e.g., to review rental reports, investigate any suspicious or unusual reported activities, manage the stock levels or maintenance schedules of the assets or rental units 12 located in the stores 18, and preparing invoicing for the customers).

The system for tracking and managing assets in remote equipment rental stores can in various configurations enhance value for rental equipment company customers and the rental equipment company itself in a number of ways, including for example: (a) Counter Staff Efficiency: Renter self-service allows higher revenues without adding staff; (b) Convenience Rental Income: On-site location of equipment encourages unplanned rentals; (c) Delivery Cost Savings: On-site location of equipment reduces multiple delivery charges; (d) Expansion into Consumables: The secure container may be stocked with standard consumables; (e) Reduction in Warehouse Space: Virtual warehousing is achieved through containerized inventory; (f) Consolidated Billing Savings: The system will allow automated, consolidated monthly billing; (g) Container Rental Income: Many end-users will be willing to rent the container from the rental equipment company to provide secure storage for equipment; (h) Theft Control: A secure facility with a lock, RFID enabled access, or video monitoring provides theft prevention; (i) Inventory Visibility: Tagging all assets in containers and warehouses will give real-time inventory status across all locations; and/or (j) Usage-Driven Maintenance: On-board sensors to track usage provide for the efficient scheduling of maintenance. Not all of the embodiments will provide all of the above features, and some embodiments may provide additional or different features.

Although the embodiments of the invention have been discussed above in the context of a remote rental store, some of the features described above could be applied in non-rental environments. For example, a construction or demolition company could operate its own remote stores 18 by loading up shipping containers (each equipped with a store monitor 16) with industrial and/or construction equipment units 12 each having a data collection unit 14, and with consumable items 13, and then providing those containers to the sites that the company is working at as needed. Such an equipment provisioning and tracking system would operate similar to the rental store system described above, except that rental charges would typically not be calculated or invoiced for (although in some embodiments, internal company invoicing may be used to track or allocate project costs). Such a system may, in some applications, assist the equipment owning company in effective job costing and provide usage information that can assist when estimating future jobs.

While the present invention is described within the context of active RFID known to those skilled in the art, it will be understood that the present invention may be implemented using any known wireless communications mechanism, such as various ISM-license free and licensed bands including 433, 868, 900, 1200, 2400, 5800 Mhz. The modulation technique is generally dependent on the band and the RFID TAG application requirements, but may include FM, QSPK, DSSS, FHSS, and other narrow and wide band modulation techniques.

The above-described embodiments of the present application are intended to be examples only. Alterations, modifications and variations may be effected to the particular embodiments by those skilled in the art without departing from the scope of the application, which is defined by the claims appended hereto.

We claim:

1. A remote rental store system comprising:
(a) a remote store monitor located at a rental location, the remote store monitor including:
(i) a wireless receiver for receiving wirelessly transmitted signals from a plurality of mobile rental units located at the remote rental location; and
(ii) a store controller connected to the wireless receiver for generating rental unit usage data for the rental units in dependence on the signals and providing the rental unit status data over a communications link;
and
(b) a management controller, at a location that is remote from the rental location, for receiving the rental unit usage data through the communications link from the store controller and periodically determining a rental charge for the rental units in dependence on the rental unit usage data.

2. The rental store system of claim 1 wherein the rental unit usage data is indicative of time periods that the rental units are in use at the rental location and the management controller is configured for determining the rental charge for the at least some rental units based at least in part on the duration of the time periods that the rental units are determined to be in use.

3. The rental store system of claim 2 including a secure enclosure in which the mobile rental units can be stored, wherein the store controller is configured for determining in dependence on the received signals if the rental units are inside or outside of the enclosure, where a determination that a rental unit is outside of the enclosure indicates that the rental unit is in use and a determination that a rental unit is inside of the enclosure indicates that the rental unit is not in use.

4. The rental store system of claim 3 wherein the store controller is configured for determining that a rental unit is outside of the enclosure if a signal from the rental unit is not received by the store monitor for a predetermined duration of time.

5. The rental store system of claim 3 wherein the store controller is configured for determining that a rental unit is outside of the enclosure if a predetermined signal from the rental unit is received.

6. The rental store system of claim 3 wherein the secure enclosure is a mobile shipping container to which the store monitor is secured.

7. The rental store system of claim 2 wherein some of the wirelessly transmitted signals include operating information indicative of at least one of the following (a) whether the rental unit transmitting the signals has a running engine; (b) whether the rental unit transmitting the signals is moving; (c) a physical location of the rental unit transmitting the signals; and (d) whether an operator ID has been provided to the rental unit transmitting, and the operating information is used for determining if the rental unit transmitting the signals is in use.

8. The rental store system of claim 1 wherein there is a plurality remote rental store locations and at least one of the remote store monitors is located at each of the remote rental store locations, the management controller being configured for receiving rental unit usage data from each of the remote store monitors over respective communications links therewith and periodically determining rental charges for rental units at each of the plurality of remote rental store locations in dependence on the rental unit usage data.

9. The rental store system of claim 1 wherein the management controller is configured for generating an invoice for a user of the rental store in dependence on the determined rental charges.

10. The rental store system of claim 1 wherein the management controller includes a database of operating benchmarks for at least some of the rental units and the management controller is configured for comparing information derived from the rental usage data with the operating benchmarks to determine if proposed maintenance is required for one or more of the at least some rental units.

11. The rental store system of claim 1 wherein the management controller is configured for receiving through the remote store monitor third party equipment usage data generated by the store controller in dependence of signals received from equipment units that are owned by a third party entity that is independent from an entity operating the rental store system, wherein the management controller includes a database of operating benchmarks and is configured for comparing information derived from the third party equipment usage data with the operating benchmarks and generating reports for the third party entity based on the comparison.

12. A method for operating a remote rental facility having a secure enclosure containing a plurality of rental units that are enabled to emit RF signals, comprising:
monitoring, at the remote rental facility, for RF signals transmitted by the rental units;
generating rental unit usage data for the rental units in dependence on the RF signals and providing the rental unit status data to a location remote from the rental facility through a communications link; and
receiving, at the location remote from the rental facility, the rental unit usage data through the communications link and periodically determining a rental charge for the rental units in dependence on the rental unit usage data.

13. The method of claim 12 wherein the rental unit usage data is indicative of time periods that the rental units are in use and including determining a duration of the time periods that the rental units are in use, wherein the rental charge for the at least some rental units are based at least in part on the duration of the time periods that the rental units are determined to be in use.

14. The method of claim 12 wherein the RF signals are monitored through a receiver and including determining in dependence on the monitored RF signals a proximity of the rental units to the receiver, where a determination that a particular rental unit is in use depends on determined proximity of the particular rental unit to the receiver.

15. The method of claim 12 including generating an invoice for a user of the rental store in dependence on the determined rental charges.

16. A method of operating an unattended rental location, comprising:
providing a plurality of mobile rental units in a secure enclosure at the rental location, each of the mobile rental units having an associated RF signal emitting device attached thereto for emitting an RF signal that includes identification information identifying the rental unit;
monitoring at the secure location for RF signals emitted by the mobile rental units;
determining, in dependence on the monitoring, when the mobile rental units are in use at the rental location and tracking over a predetermined time period for each of the mobile rental units a cumulative time duration that the mobile rental unit is determined to be in use; and
determining a rental charge for each of the mobile rental units for the predetermined time period based on the cumulative time duration that the mobile rental unit is in use.

17. The method of claim 16 wherein the secure enclosure is a shipping container, wherein providing a plurality of mobile rental units in a secure enclosure at the rental location includes (a) providing at a loading site remote from the rental location a shipping container having a monitoring system secured thereto for performing the monitoring for RF signals emitted by the mobile rental units; and (b) selecting the mobile rental units and placing at least some of the mobile rental units into the shipping container at the loading site, securing the shipping container shut, and then moving the shipping container to the rental location.

18. The method of claim 17 wherein the mobile rental units are selected based on information about a phase of a project that is being performed at the rental location, wherein different combinations of rental units are selected for different phases.

19. The method of claim 16 wherein determining, in dependence on the monitoring, when the mobile rental units are in use at the rental location includes determining when each of the mobile rental units is taken outside of the container.

20. The method of claim 16 including providing consumable items each having an identification device in the secure enclosure, recording identification information from the identification devices when the consumable items are removed from the secure enclosure and determining an amount to charge for the consumable items based on the recorded identification information.

21. A remote equipment provisioning system comprising:
a mobile container having a lockable door;
a plurality of mobile equipment units located within the container, each of the mobile equipment units having an attached RF signal emitting device attached thereto for emitting an RF signal that includes identification information identifying the mobile equipment unit; and
a store monitor secured to the container, the store monitor including: (i) a wireless RF receiving device for receiving the RF signals emitted within a coverage area thereof by the mobile equipment units; and (ii) a store controller connected to the wireless receiver for generating mobile equipment unit status data for the mobile equipment units in dependence on the RF signals received by the RF receiving device and transmitting the mobile equipment unit status data over a wireless communications link.

22. The system of claim 21 wherein the store controller is configured for determining in dependence on the RF signals received by the RF receiving device when one or more of the mobile equipment units are taken outside of the container, and the mobile equipment unit status data includes information identifying mobile equipment units that have been taken outside of the container and the duration that the identified mobile equipment units have been taken outside of the container.

23. The system of claim 21 wherein on at least some of the mobile equipment units the RF signal emitting device is an active RFID device integrated into a data collection unit, each data collection unit including a processor and a visible status indicator responsive to the processor for visually indicating if a mobile unit is in rental state, the processor being configured for detecting based on information received by the data collection unit if the mobile equipment unit to which the data collection unit is attached is in a rental state and if so causing the visible status indicator to indicate the rental state.

24. The system of claim 21 wherein the RF signal emitting device is an active RFID device integrated into a data collection unit, each data collection unit including a processor and a plurality of sensors for detecting unit operating information, the sensors including an accelerometer, the RF signal emitting device being configured for including a representation of the detected unit operating information in the RF signal emitted thereby.
